(19) United States
(12) Patent Application Publication
(10) Pub. No.: US 2004/0092690 A1
(43) Pub. Date: May 13, 2004

(54) Organic semiconductor, production method therefor and the use thereof

(76) Inventors: Mark Giles, Southampton (GB); Henning Rost, Erlangen (DE)

Correspondence Address: YOUNG & THOMPSON, 745 SOUTH 23RD STREET 2ND FLOOR, ARLINGTON, VA, 22202

(21) Appl. No.: 10/451,108

(22) PCT Filed: Dec. 17, 2001
(86) PCT No.: PCT/DE01/04743

(30) Foreign Application Priority Data
Dec. 20, 2000 (DE) 100 63 721.3

(51) Int. Cl. C08F 12/02

(52) U.S. Cl. 526/346

(57) ABSTRACT

A novel class of organic semiconductor with a high charge carrier mobility by high regio-regularity. The regio-regularity is produced by the production of the polymer, starting from an AB elimination of the monomers.

The invention relates to a new class of semiconductor with high regio-regularity.

To produce an organic thin-film transistor or an organic field-effect transistor (OFET), an organic semiconductor material that can be easily applied as a film and can be processed and at the same time has a high charge carrier mobility is used.

An organic material is known that already has a satisfactorily high charge carrier mobility of 0.22 cm²/Vs, i.e. the poly(2,5-thienylene vinylene) “PTV”. This material can however be manufactured only by means of an expensive precursor process and is itself insoluble, unmeltable and thus not processible. This material is therefore expensive and not suitable for the manufacture of thin-layer films. It must be manufactured in-situ on the substrate.

Therefore, early trials were begun to produce other polythiophenes with the same charge carrier mobility but better processibility (A. Assadi, C. Svensson, M. Willander and O. Inganäs “Field effect mobility of poly(3-hexylthiophene)” Appl. Phys. Lett. 53(3): 195-7, 1988). The 3-alkyl substituted thiophenes in particular showed a better processibility.

The 3-alkyl substitutes of the thiophene could be inserted into a polymer chain with two different orientations. One is the head-tail (HT) linkage and the other is the head-head (HH) linkage. In this connection, regio-regular means that only one of the types of linkage (HH or HT) is realized. A high regio-regularity also produces a good charge carrier mobility. The highest mobility measured so far in films of this kind amounted to approximately 0.015-0.045 cm²/Vs (Z. Bao, A. Dodabalapur and A. J. Lovinger. “Soluble and processible regioregular poly(3-hexylthiophene) for thin film field-effect transistor applications with high mobility” Appl. Phys. Lett. 69(26): 4108-10, 1996).

The commercially available 3-alkyl substituted thiophenes have a regio-regularity of approximately 98% and thus do not have a perfect order. The achievement of a regio-regularity of 100% is, however, sought in order to obtain a higher charge carrier mobility in the polymer.

The object of the invention is therefore to provide an organic material that has a high regio-regularity, to provide a method of manufacture for production of this material and finally to specify preferred uses of the material.

The object of the invention is a polyarylene vinylene (PAV) of the general formula I

—(Ar(R)—CH═CH)ₙ—

in which

Ar stands for an aryl group with 4 to 14 C atoms and (R) means that Ar can have one or more substituents R that can be the same or different and represent a phenyl group or phenyloxy group or a straight-chained or branch or cyclical alkyl or alkoxy group with 1 to 25 C atoms, whereby one or more of the CH₂ groups that are not adjacent can be replaced by —O—, —S—, —CO—, —COO—, —OCO—, —NR¹—, —NR²R³)⁺A⁻, —O—COO—, —NR¹—CO—NR¹— or —CONR⁴ and whereby one or more H atoms can be replaced by F, CN, Cl, Br, I or an aryl group with 4 to 14 C atoms, that can be substituted by one or more non-aromatic residues R; whereby

R¹, R², R³, R⁴ are the same or different and stand for aliphatic or aromatic hydrocarbon residues with 1 to 25 C atoms or also H and

A⁻ signifies a simple charged anion,

with the PAV having a regio-regularity of more than 98%, especially 99% or more, preferably 99.5% or more or particularly preferred 100%, in the chain linkage.

Furthermore an object of the invention is a method for the manufacture of a polyarylene vinylene (PAV) with a high charge carrier mobility, particularly of 10⁻⁴ cm²/Vs or higher, preferably 10⁻³ cm²/Vs or higher, particularly preferred 10⁻² cm²/Vs or higher, whereby by means of an AB elimination a more than 98%, particularly 100% regio-regular linkage of the monomers is achieved. In particular a formaldehyde group —CH═O stands for A and one of the groups —CH₂PPh₃]⁺Cl⁻, —CH₂PO(OEt)₂ or (—CH₃) for B, that have a regio-regular abreaction with each other within the context of a cross-linking condensation reaction. Finally, other various applications of the semiconducting material, for example for organic light emitting diodes, photocells, field emission displays or sensors, and an integrated circuit on the basis of organic material are also objects of the invention.

Preferably, a method is employed that leads to a regio-regular HT (head-tail) linkage of the monomers.

The polymers generally have between 2 and 15000 monomer units, preferably 10 to 7500, particularly preferred 100 to 5000 and totally preferred between 250 and 2000 monomer units, that are regio-regular linked up to 98% or more. These values are preferably chosen so that the Theological and mechanical behavior of the polymers and the resulting films are optimized.

The formation of the polymer from similar or dissimilar monomer units depends on requirements and can be controlled by the addition of various monomer units during production. This then results in copolymers, i.e. polymers that are constructed of at least two different monomer units.

Monomer units in which Ar takes the following significance are preferred.

### Ar

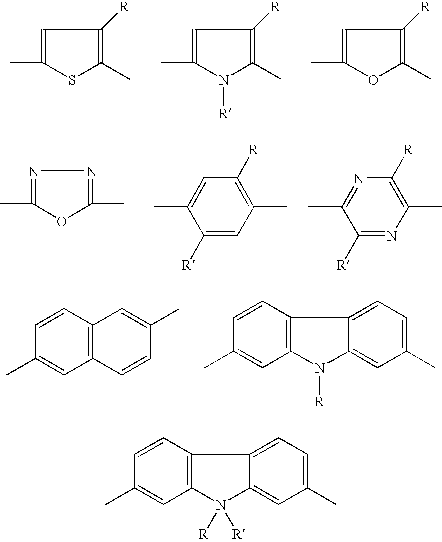

where

R, R′ can be similar or dissimilar and represent a phenyl group or a phenyloxy group or a straight-chained, branched or cyclical alkyl group or alkoxy group with 1 to 25 C atoms, with it being possible to replace one or more of the non-adjacent CH₂ groups by —O—, —S—, —CO—, —COO—, —OCO—, —NR¹—, —NR²R³)⁺A⁻, —O—COO—, —NR¹—CO—NR¹— or —CONR⁴ and it being possible to replace one or more H atoms by F, CN, Cl, Br, I or by an aryl group with 4 to 14 C atoms, that can be substituted by one or more non-aromatic residues R; whereby R¹, R², R³, R⁴ are similar or different and represent aliphatic or aromatic hydrocarbon residues with 1 to 25 C atoms or also H.

The use of a 3-alkyl substituted thiophene as Ar is particularly preferred, with a poly(3-alkyl 2.5 thienylene vinylene) (PTV) being produced by the carbonyl olefination method.

The use of an alkyl group or alkoxy group with 6 to 24 C atoms is preferred as R.

In the following, the process of a regio-regular linkage to more than 98% by the carbonyl olefination method is explained in more detail by means of an example.

### Synthesis Possibility I

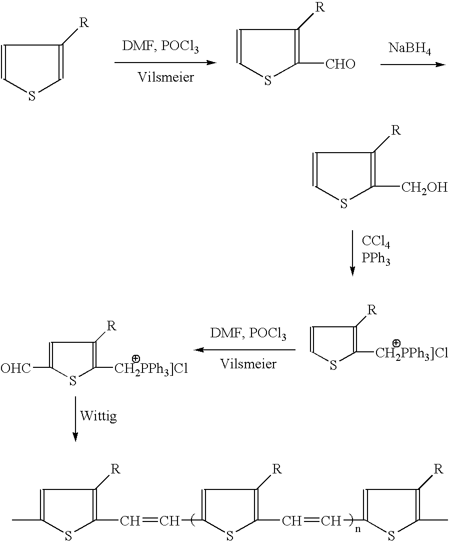

100% regio-regular poly(3-alykl 2.5 thienylene vinylenes) (PTV)

### Synthesis Possibility II

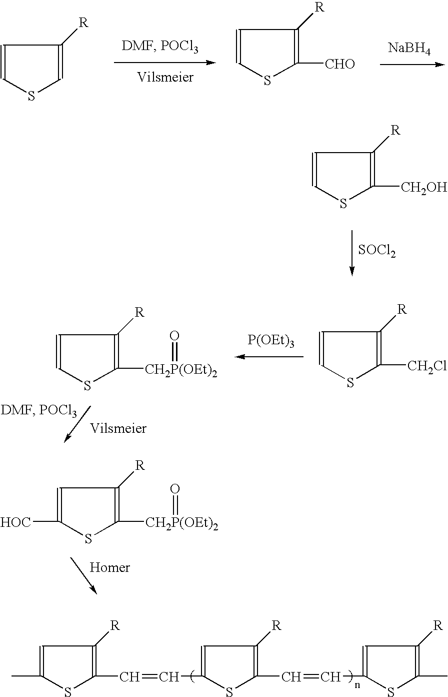

100% regio-regular poly(3-alykl 2.5 thienylene vinylenes) (PTV)

whereby R has the significance given above.

The polymers are preferably used as organic semiconductors, particularly preferred as a functional layer, e.g. an integrated circuit, an organic diode, a photocell, a field emission indication or a sensor.

1. Polyarylene vinylene (PAV) of the general formula I
—(Ar(R)—CH═CH)ₙ—
in which
Ar stands for an aryl group with 4 to 14 C atoms and (R) means that Ar can have one or more substituents R that can be the same or different and represent a phenyl group or phenyloxy group or a straight-chained or branch or cyclical alkyl or alkoxy group with 1 to 25 C atoms, whereby one or more of the CH₂ groups that are not adjacent can be replaced by —O—, —S—, —CO—, —COO—, —OCO—, —NR¹—, (—NR²R³)⁺A⁻, —O—COO—, —NR¹—CO—NR¹— or —CONR⁴ and whereby one or more H atoms can be replaced by F, CN, Cl, Br, I or an aryl group with 4 to 14 C atoms, that can be substituted by one or more non-aromatic residues R; whereby
R¹, R², R³, R⁴ are the same or different and stand for aliphatic or aromatic hydrocarbon residues with 1 to 25 C atoms or also H and
A⁻ signifies a simple charged anion,
whereby the PAV has a regio-regularity of more that 98% in the chain linkage.

2. Polyarylene vinylene (PAV) in accordance with claim 1, with between 2 and 15000 monomer units being regio-regular linked.

3. Polyarylene vinylene (PAV) in accordance with one of claims 1 or 2, constructed of at least two different monomer units.

4. Method for the manufacture of a polyarylene vinylene (PAV) with a high charge carrier mobility with a more than 98% regio-regular linkage of the monomers being achieved by an AB elimination, with A and B representing two functional organic residues at an aromatic substance that bring about a regio-regular linkage of the affected monomers in a condensation reaction.

5. Method in accordance with claim 4, whereby A represents —CH═O and B —CH₂PPh₃]⁺X⁻ (X=halogen) or —CH₂PO(OEt)₂, that regio-regular abreact with each other in the course of a condensation reaction.

6. Method in accordance with one of claims 4 or 5, whereby a regio-regular head-tail (HT) linkage of the monomers occurs.

7. Method in accordance with one of claims 4 to 6, whereby copolymers are produced by the addition of various monomer units during manufacture.

8. Polyarylene vinylene is produced by a method in accordance with one of claims 4 to 7.

9. Integrated circuit, organic light emitting diode, photocell, field emission display or sensor containing a polyarylene vinylene in accordance with one of claims 1 to 3 or 8.

10. Integrated circuit based on organic materials, with a functional polymer being a more than 98% regio-regular organic polymer composed of monomer units of the general formula I.
